(19) United States
(12) Patent Application Publication
(10) Pub. No.: US 2009/0282212 A1
(43) Pub. Date: Nov. 12, 2009

(54) SYSTEM FOR ENABLING ACCESS TO ADDITIONAL MEMORY AND STORAGE CAPACITY

(75) Inventor: Harold L. Peterson, Scotts Valley, CA (US)

Correspondence Address: Patent Venture Group, 10788 Civic Center Drive, Suite 215, Rancho Cucamonga, CA, 91730-3805, US

(73) Assignee: DIGITAL DELIVERY NETWORKS, INC., Scotts Valley, CA (US)

(21) Appl. No.: 12/505,704

(22) Filed: Jul. 20, 2009

Related U.S. Application Data
(63) Continuation-in-part of application No. 11/879,213, filed on Jul. 16, 2007.

(51) Int. Cl. G06F 12/02; G06F 12/00

(52) U.S. Cl. 711/173; 711/E12.001; 711/E12.002

(57) ABSTRACT

An electronic device including a controller having a processor that works with a memory or a storage. The memory or storage has an additional partition that is prevented from being accessed by the processor until enabled with an access logic and a key associated with this partition. A user of the device upgrades it to access the additional partition by running the access logic in the device, being informed that an upgrade is permitted, determining if they wish the upgrade and, if so, then purchasing it, the key being transferred to the device from an external source, and the key being applied with the access logic to enable the partition.

### CROSS-REFERENCE TO RELATED APPLICATIONS

This is a continuation-in-part of application Ser. No. 11/879,213, filed Jul. 16, 2007, hereby incorporated by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Technical Field

The present invention relates generally to electrical computers and digital processing systems, and more particularly to selectively restricting access to memory and/or storage areas.

2. Background Art

The variety of consumer electronic devices that is available continues to grow at a very rapid rate. For example, we have many types of personalized general computing devices. One common example here is the personal computer (PC), which includes desktop units (i.e., “traditional” PCs) and portable varieties such as laptops, notebooks, and netbooks. We have recording equipment, including digital still and video cameras as well as audio recording devices. We have personal playback equipment, such as MP3 and other format music players, e-book players, portable digital versatile disc (DVD) players. And we also have general playback equipment, such as digital video recorders (DVRs), multi-player gaming counsels, and digital frames that play images, movies, and audio clips.

The quantity of electronic devices that consumers use also continues to grow, but at a slower rate. Some examples here are personal communications devices, with cellular telephones having subsumed personal digital assistants (PDAs) and now become the ubiquitous example.

The example of the cellular telephone further illustrate how the distinctions between consumer electronic devices are blurring, and perhaps even how the number of such devices that a person uses may stabilize or start to decrease. For instance, many modern cellular telephones run application programs like many PCs; capture images, video, and audio like many digital cameras, camcorders, and recorders; and playback commercial content or what they have been used to capture or record.

While it is probably impossible to exhaustively list modern consumer electronic devices here, and any such list would quickly be obsolete, aspects common to essentially all of these devices are that they have data memory, or data storage, or both (hereinafter simply memory and storage).

The terms “memory” and “storage” are often loosely and interchangeably used and it is hard to define one term without using the other. For example, one definition of memory is “[a] functional unit to which data can be stored and from which data can be retrieved” (United States Patent Classification (USPC) System, class 711 glossary, United States Patent and Trademark Office). Here, however, it is important to draw and maintain a distinction. For the present discussion the term “memory” is used in a dynamic sense and the term “storage” is used in a static sense. This can be seen easily with an example. Apple Corporation of Cupertino, Calif. presently markets the MacBook™ personal computer. Upon purchase the dynamic memory, the random access memory (RAM) in this particular device, is usually one gigabyte (GB) and the static memory, the hard disc drive storage unit in this particular device, is often 320 GBs. However, both of these can be expanded, say to two GB and to 500 GB.

Expanding or “upgrading” the memory and/or storage capacity in consumer electronic devices presents a lot of problems. Historically, there have been two ways to do this: replace one or more existing low capacity units with higher capacity units or install additional units. Both approaches burden the end user and even society as a whole. For example, both are expensive, require some degree of technical skill, and inherently expose the device to a of risk of damage. Replacement of units often results in still usable low capacity units simply being discarded as waste and installing additional units is often not a possible option. For instance, continuing with the MacBook™ example, the MacBook has a finite number of slots for memory units and a finite amount of internal space for storage units. Upon purchase these slots are usually all fully occupied. Thus replacement is the only option left if a user wants to expand or upgrade the dynamic memory or the static storage capacities in this consumer electronic device.

Something not widely known, but becoming increasingly common, is that many consumer electronic devices are now sold with more memory and/or storage capacity than they are represented or advertised as having. Various reasons lead to this. For example, devices and marketing campaigns for them may be designed based on currently available components, only to have the devices actually manufactured using later available components that have greater capacities. Or manufactures may wish to provide different options for a device, say one GB entry level, two GB regular level, and four GB professional level devices but find it inefficient to purchase, stock, and manufacture using different capacity memory and/or storage units.

The manufacturer (or the vendor if the device is a “house branded” one commissioned by a major vendor) then faces the choice of giving end purchasers more than they are paying for. Where, for instance, an entry level device typically is priced essentially at cost, to entice new consumers to a brand or in the hopeful expectation of profiting eventually from tied-in sales. A manufacturer or vendor then clearly does not want consumers to be able to buy the entry level device at the lowest price and still actually get the professional level device. The manufacturer therefore may take the additional step of “under configuring” the device, for example, by setting it to use only one GB of four GB of dynamic memory that is actually present or by setting it to use only 500 GB of static storage when 750 GB is actually present. The vendor then may also have some follow-on issues related to this. For instance, if it becomes widely known by purchasers that devices are under configured, potential purchasers may seek to purchase devices that have under configured capacity, thus skewing the market to such devices. Purchasers attempting to reconfigure device memory and/or storage capacities themselves are also likely create directly related or peripheral technical support issues that the vendor then may have to deal with.

Conversely, something that is increasingly appreciated is that manufacturing consumer electronic devices with more memory and/or storage capacity is relatively inexpensive. As implied above, the economies of scale can offset the cost of using greater capacity components. For instance, a 750 GB storage component does not cost 1.5 times as much as a 500 GB component. It is typically only 1.2 times as much (i.e., merely 20% more, rather than 50% more). Furthermore, this cost may effectively be reduced to below 15% if the manufacturer purchases, say, 10,000 units of the 750 GB components rather than 5,000 units each of 750 GB and 500 GB components. Availability issues, stocking, production line change over, end device configuration, after sale technical support complexity, etc. may reduce or even eliminate all of even a 15% differential.

Summarizing, on one hand, manufacturers and vendors already have consumer electronic devices with over represented memory and/or storage capacities, or else it often is a relatively inexpensive matter to provide such devices with such capacities. On the other hand, manufacturers and vendors presently incur actual costs and other disincentives in making these capacities available to the purchasers and end users of these devices. This situation leaves manufacturers, vendors, and consumers all disadvantaged, and solutions are accordingly desirable to address this.

### BRIEF SUMMARY OF THE INVENTION

Accordingly, it is an object of the present invention to provide a system for enabling access to additional memory and storage capacity in an electronic device.

Briefly, one preferred embodiment of the present invention is an electronic device including a controller having a processor that works with a memory and a storage. The memory has a primary memory partition that is accessible by the processor and a secondary memory partition that is prevented from being accessed by the processor until enabled when an access logic is run in the electronic device with a key associated with the secondary memory partition. The storage similarly has a primary storage partition that is accessible by the processor and a secondary storage partition that is prevented from being accessed by the processor until enabled when said access logic is run in the electronic device with a key associated with the secondary storage partition.

Briefly, another preferred embodiment of the present invention is an electronic device including a controller having a processor that works with a memory. The memory has a partition that is prevented from being accessed by the processor until enabled when an access logic is run in the electronic device with a key associated with the partition.

Briefly, another preferred embodiment of the present invention is an electronic device including a controller having a processor that works with a storage. The storage has a partition that is prevented from being accessed by the processor until enabled when an access logic is run in the electronic device with a key associated with the partition.

Briefly, another preferred embodiment of the present invention is a method for manufacturing an electronic device having additional memory and storage capacities. The electronic device is built to include a controller having a processor that works with a memory and a storage. The memory is configured to have a primary memory partition that is accessible by the processor and to have at least one secondary memory partition that is prevented from being accessed by the processor until enabled by an access logic running in the electronic device with a key associated with the secondary memory partition. The storage is configured to have a primary storage partition that is accessible by the processor and further to have at least one secondary storage partition that is prevented from being accessed by the processor until enabled by the access logic running in the electronic device with a key associated with the secondary storage partition.

Briefly, another preferred embodiment of the present invention is a method for manufacturing an electronic device having additional memory capacity. The electronic device is built to include a controller having a processor that works with a memory. The memory is configured to have a partition that is prevented from being accessed by the processor until enabled by an access logic running in the electronic device with a key associated with the partition.

Briefly, another preferred embodiment of the present invention is a method for manufacturing an electronic device having additional storage capacity. The electronic device is built to include a controller having a processor that works with a storage. The storage is configured to have a partition that is prevented from being accessed by the processor until enabled by an access logic running in the electronic device with a key associated with the partition.

Briefly, another preferred embodiment of the present invention is a method for a user of an electronic device to upgrade access to an additional memory capacity and to an additional storage capacity when the electronic device includes a processor, a memory, and a storage wherein the memory has a memory partition that is prevented from being accessed by the processor until enabled by an access logic being run in the electronic device with a key associated with the memory partition, and wherein the storage has a storage partition that is prevented from being accessed by the processor until enabled by said access logic being run in the electronic device with a key associated with the storage partition. The access logic is run in the electronic device and the user is informed that an upgrade permitting access to the additional memory capacity and the additional storage capacity is available. It is determined if the user wishes the upgrade. If so, the user is permitted to purchase the upgrade. Then the key associated with the memory partition is transferred to the electronic device from an external source, and the key associated with the storage partition is transferred to the electronic device from the external source. Then the key associated with the memory partition with the access logic is applied to enable the memory partition, and the key associated with the storage partition with the access logic is applied to enable the storage partition.

Briefly, another preferred embodiment of the present invention is a method for a user of an electronic device to upgrade access to an additional memory capacity when the electronic device includes a processor and a memory having a partition that is prevented from being accessed by the processor until enabled by an access logic being run in the electronic device with a key. The access logic is run in the electronic device and the user is informed that an upgrade permitting access to the additional memory capacity is available. It is determined if the user wishes the upgrade. If so, the user is permitted to purchase the upgrade. Then the key is transferred to the electronic device from an external source, and the key is applied with the access logic to enable the partition.

And briefly, another preferred embodiment of the present invention is a method for a user of an electronic device to upgrade access to an additional storage capacity when the electronic device includes a processor and a storage having a partition that is prevented from being accessed by the processor until enabled by an access logic being run in the electronic device with a key. The access logic is run in the electronic device and the user is informed that an upgrade permitting access to the additional storage capacity is available. It is determined if the user wishes the upgrade. If so, the user is permitted to purchase the upgrade. Then the key is transferred to the electronic device from an external source, and the key is applied with the access logic to enable the partition.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE SEVERAL VIEWS OF THE DRAWING(S)

The purposes and advantages of the present invention will be apparent from the following detailed description in conjunction with the appended figures of drawings in which:

FIG. 1 is a block diagram of an exemplary electronic device that may be used in the inventive system to have additional memory and/or storage capacity enabled;

FIGS. 2a-d are schematic block diagrams stylistically depicting how some exemplary embodiments of the access logic in FIG. 1 that can be run in alternate manners and at different times;

FIG. 3 is a block diagram of some exemplary activation mechanisms that may be used in the inventive system to enable access to additional capacities in the electronic device in FIG. 1;

FIG. 4 is a flow chart of a manufacturing process that may be used in the inventive system for manufacturing the electronic device in FIG. 1; and

FIG. 5 is a flow chart of an upgrade process that may be used in the inventive system to enable access to additional memory and/or storage capacity in the electronic device in FIG. 1 by using one of the activation mechanisms in FIG. 2.

In the various figures of the drawings, like references are used to denote like or similar elements or steps.

### DETAILED DESCRIPTION OF THE INVENTION

The present invention is a system for enabling access to additional memory and storage capacity. As illustrated in the various drawings herein, embodiments of the invention are depicted by the general reference character 10.

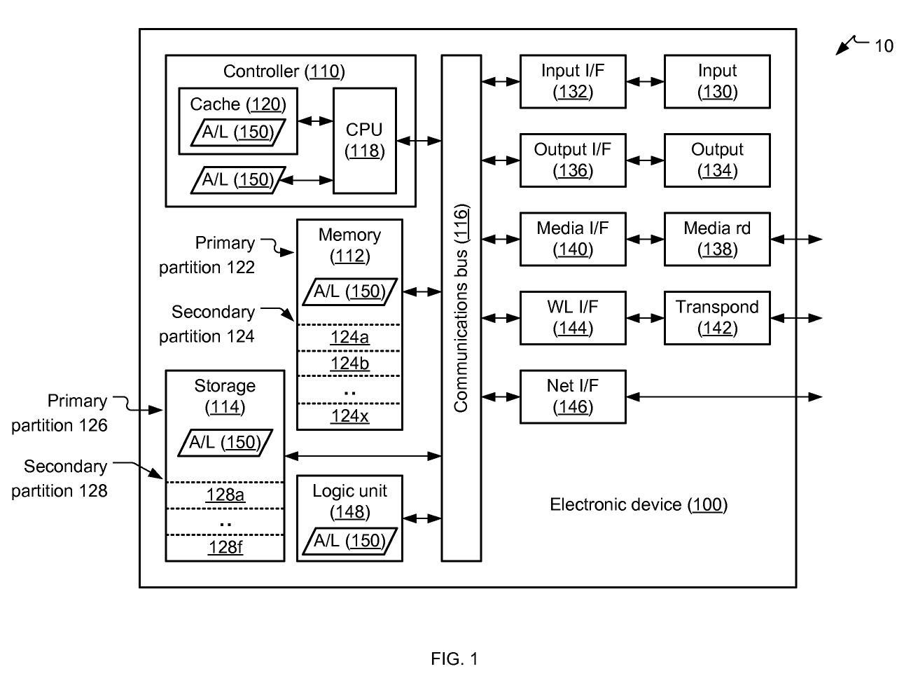

FIG. 1 is a block diagram of an exemplary electronic device 100 that may be used in the inventive system 10 and have access to additional memory and/or storage capacity enabled. The electronic device 100 includes a controller 110, a memory 112, a storage 114, and a communications bus 116 connecting all of these.

The controller 110 includes a central processing unit (CPU 118) and a cache 120. The controller 110 can include more than one CPU and it can also include multiple caches as well (e.g., one per CPU or different level caches for the CPU or CPUs). Alternately, the controller need not include any cache, but most modern microprocessor-based CPUs do and showing a cache in FIG. 1 facilitates discussion of aspects of some sophisticated embodiments of the electronic device 100.

The memory 112 includes a primary partition 122 and a partition block 124 that includes one or more secondary partitions (secondary partitions 124a-x in this example). In FIG. 1 the secondary partitions 124a-x are shown as each being the same size (i.e., capacity), but this is not a requirement. For instance, the primary partition 122 might have a one GB capacity and the partition block 124 might have a three GB capacity, wherein each of the secondary partitions 124a-x has a 128 megabyte (MB) capacity. The electronic device 100 then has a potentially usable four GB total memory capacity. Alternately, the primary partition and the additional partition block might be the same but with the latter having six secondary partitions wherein two have 128 MB capacities, one has a 256 MB, capacity, one has a 512 MB capacity, and two have one GB capacities. The result is still a potentially usable four GB total capacity that is configurable in similar increments. Using either of these approaches, or yet another, is a largely a matter of design choice.

The storage 114 similarly includes a primary partition 126 and a partition block 128 that here includes secondary partitions 128a-f. For instance, the primary partition 126 here can have a 500 GB capacity and the additional partition block 128 can have a 250 GB capacity wherein each of the secondary partitions 128a-f has a 50 GB capacity.

The communications bus 116 connects the controller 110, the memory 112, and the storage 114, and here in FIG. 1 it also connects a number of peripheral elements in the electronic device 100. These include an input device 130 and an input interface 132; an output device 134 and an output interface 136; a media reader 138 and a media interface 140; a wireless transponder 142 and a wireless interface 144; a network interface 146; and a logic unit 148.

The electronic device 100 shown in FIG. 1 additionally includes one other important element: an access logic 150 comprising instructions that are executable by the CPU 118 or the logic unit 148. At the point when a user receives the electronic device 100 the access logic 150 may already be present in the controller 110, e.g., in read only memory (ROM) or flash memory there, or present in the logic unit 148, e.g., in similar memory there, or it may be stored in the storage 114. Alternately, the access logic 150 can be received into the electronic device 100 later via the media reader 138 off of a computer readable storage media, or it can be received via the wireless transponder 142 or the network interface 146. Optionally, if it has newly been received in one of these manners, the access logic 150 can be stored in the storage 114.

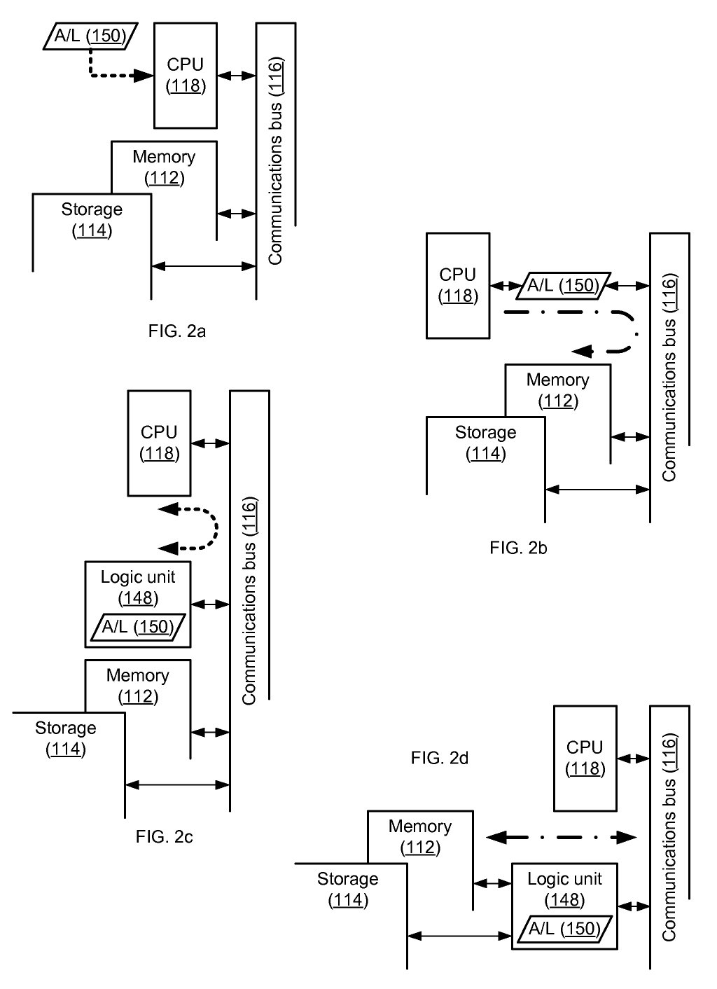

FIGS. 2a-d are schematic block diagrams stylistically depicting how some exemplary embodiments of the access logic 150 can be run in alternate manners and at different times.

In the case in FIG. 2a the access logic 150 is run by the CPU 118 when starting up the electronic device 100. Here the access logic 150 “tells” the CPU 118 what the enabled capacities of the memory 112 and/or storage 114 are, and the CPU 118 thereafter should proceed as if only these capacities are present. This approach is suitable for many electronic devices 100, but some that do not perform elaborate start-up configuration it may be unsuitable and for others it may be unduly vulnerable to hacking.

The case in FIG. 2b takes the case in FIG. 2a to a logical end. The access logic 150 is run continually by the CPU 118, being logically interposed so that the CPU 118 only “sees” the enabled capacities. This approach is avoids the noted start-up limitation and is less vulnerable to hacking, but at the expense of some added burden on the CPU 118.

In the case in FIG. 2c the access logic 150 is run by the logic unit 148 at start up of the electronic device 100. The access logic 150 here can “tell” the CPU 118 what the enabled capacities are or it can logically interpose itself temporarily so that the CPU 118 only “sees” the enabled capacities during start-up and session configuration routines. This approach is also somewhat harder to hack. Additionally, it can provide design and manufacturing advantages. For instance, while the logic unit 148 is depicted in the figures as a single discrete unit, one or more instances of it can instead be integrated into modules or units of the memory 112 and/or storage 114. A manufacturer of the electronic device 100 then, for example, can simply buy hard disk drives that already have integral logic units 148 and thus not have to be concerned with most details of the logic unit 148 or access logic 150.

The case in FIG. 2d takes the case in FIG. 2c to a logical end. The access logic 150 is run continually by the logic unit 148, effectively acting as if the logic unit 148 is physically interposed between the CPU 118 and the memory 112 and/or storage 114. Here the CPU 118 is only effectively able to “see” what the access logic 150 allows it to see. The logic unit 148 used here can be designed to strongly thwart hacking and, as in the case in FIG. 2c, it and the access logic 150 can optionally be integrated into modules or units of the memory 112 and/or storage 114.

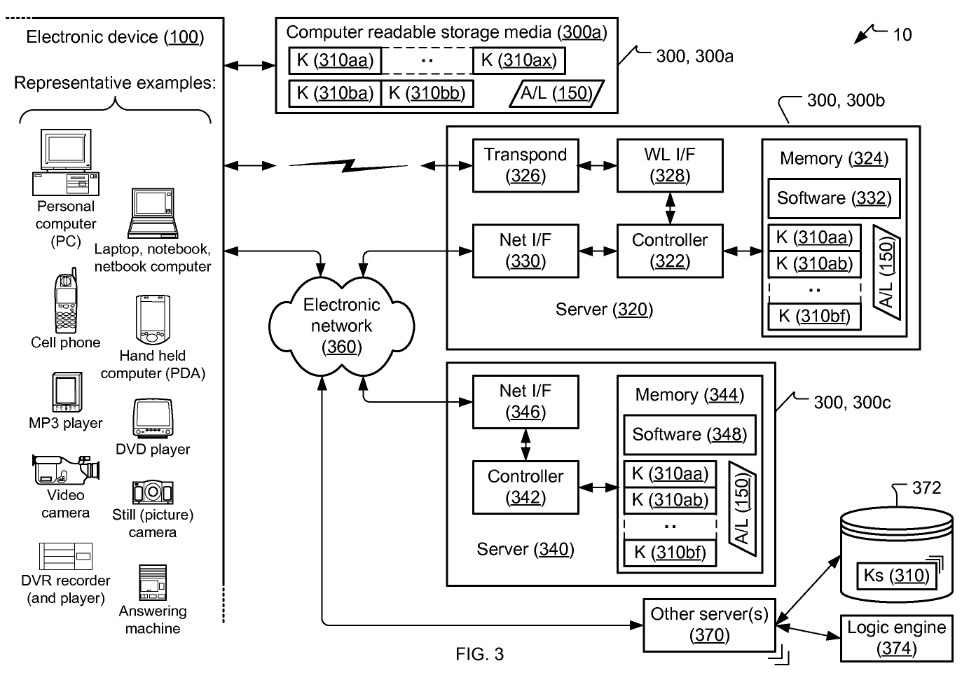

FIG. 3 is a block diagram of some exemplary activation mechanisms 300 that may be used in the inventive system 10 to enable access to additional capacities in the electronic device 100 in FIG. 1. Briefly, the activation mechanisms 300 work with an instance of the access logic 150 in the electronic device 100, optionally providing or updating the access logic 150 if it is not already present or if it is obsolete, to procure keys 310 that the access logic 150 uses to “unlock” and thus enable additional capacity in the memory 112 or the storage 114. The activation mechanisms 300 shown in FIG. 3 include a media-based mechanism 300a, a wireless-based mechanism 300b, and a physical network-based mechanism 300c.

Turning first to the media-based mechanism 300a, this may be embodied in a computer readable storage media that the media reader 138 of the electronic device 100 can read. Accordingly, this media can be a floppy disc, tape, CD, DVD, USB flash memory, external hard drive, etc. This list is not exhaustive and it should be appreciated that the nature of the media is not a limitation, as long as the media is computer readable. The media-based mechanism 300a includes one or more keys and it optionally may also include a copy of the access logic 150. If a copy of the access logic 150 is present and the nature of the media permits this, the access logic 150 may further optionally automatically execute when the media-based mechanism 300a is loaded into and read by the electronic device 100.

In FIG. 3 the keys 310 present in the media-based mechanism 300a include keys 310aa-ax, which respectively are associated with the secondary partitions 124a-x in the memory 112 of the electronic device 100, and keys 310ba-bb, which respectively are associated with the secondary partitions 128a-b in the storage 114 of the electronic device 100. The keys 310aa-ax, 310ba-bb“unlock” the units of memory or storage that they are associated with. In this manner keys 310aa-ax may be used to unlock any or all of the secondary partitions 124a-x to increase the usable capacity of the memory 112 from one GB to up to four GB. Similarly, keys 310ba-bb may be used to unlock either or both of the secondary partitions 128a-b to increase the usable capacity to the storage 114 from 500 GB to up to 600 GB (but not all the way to the potential total of 750 GB because keys associated with or corresponding to the secondary partitions 128c-e are not present in the media-based mechanism 300a in this example).

Turning now to the wireless-based mechanism 300b, this is embodied in a server system 320 that includes a controller 322, a memory 324, a wireless transponder 326 and a wireless interface 328, and an optional network interface 330. The memory 324 here further includes a software module 332, an optional copy of the access logic 150, and keys 310aa-ax (respectively associated with the secondary partitions 124a-x in the memory 112 in the electronic device 100), and keys 310ba-bf (respectively associated with the secondary partitions 128a-b in the storage 114 in the electronic device 100). Note, the server system 320 here may have copies of all of the keys 310 for all of the units of memory and storage in all of the electronic devices that the server system 320 may work with.

Turning next to the physical network-based mechanism 300c, this is also embodied in a server system 340. Potentially the server system 340 can be the same as the server system 320, but this is not a requirement and to emphasize this the server system 340 here is depicted with different components. Continuing, the server system 340 includes a controller 342, a memory 344, and a network interface 346. The memory 344 here further includes a software module 348, an optional copy of the access logic 150, and keys 310aa-ax. The software module 348 may be, but need not necessarily be, the same as the software module 332, and the remarks above about the keys apply as well here for all of the units of memory and storage in all of the electronic devices that the server system 340 may potentially work with.

FIG. 3 further includes two additional objects that merit discussion. An electronic network 360 is shown for use with the server system 340, and optionally also with the server system 320. Furthermore, a set of other servers 370 is shown to generically represent other systems that may be used in the greater context of the applying this invention. For instance, one of the other servers 370 might be that of a financial institution that receives payment from a user of the electronic device 100 and informs the server system 320 or the server system 340 of this, typically so that the server system 320, 340 will communicate a copy of one or more keys to the electronic device 100. Alternately, and potentially additionally, one of the other servers 370 may be a system that has a media writer with which tailored instances of the media-based mechanism 300a are created, say, to be mailed or sent by courier to a user of the electronic device 100. Still alternately, one of the other servers 370 may be a system that provides the keys 310 to the server systems 320, 340, say from a databases 372 that centrally stores the keys 310 or from a logic engine 374 that generates the keys 310.

Before wrapping up discussion of the electronic device 100 and the activation mechanisms 300 here, some additional coverage of general aspects of the secondary blocks 124, 128 is appropriate. Conceptually, when any part of a secondary block 124, 128 is unlocked or enabled it becomes part of the respective primary partition 122, 126. This can be a permanent change or, in sophisticated embodiments of the present invention, this can also be temporary.

Continuing with the ongoing examples in FIGS. 1-3, permanently unlocking a secondary partition 124a-x, 128a-f is generally straightforward. One potential problem that may arise in some types of media, however, is whether what is being unlocked is contiguous with its respective primary partition 122, 126. There are many simple solutions to this problem. First, some types of media inherently handle this, such as flash memory, which typically has a section-usage balancing mechanism. Physically non-contiguous segments here are automatically (i.e., at a low level essentially internal to the component or module) arranged to appear as if logically contiguous. Second, other types of media are used in paged manners wherein a device operating system maps physically non-contiguous segments so to appear logically contiguous (i.e., maps them from a non-contiguous address space to a contiguous one, wherein the latter is then used by applications). Third, in some devices a capability inherently exists to easily configure non-contiguous segments to be spanned together, e.g., using the disk storage management utility in Windows Vista™. Fourth, the secondary partitions 124a-x, 128a-f can be defined logically and managed as such by the access logic 150 (e.g., if key 310bf is received before any of keys 310ba-e the access logic 150 can increase the primary partition 126 from 500 GB to 550 GB by enabling the next physically contiguous segment). Fifth, the access logic 150 can work to insure the order in which keys are received, so that those received should be associated with or correspond to what is currently physically contiguous with the respective primary partition 122, 126. This fifth approach is especially easy when using the activation mechanisms 300b-c.

Temporarily unlocking a secondary partition 124a-x, 128a-f is technically also straightforward, but here many additional sophisticated advantages become possible. In embodiments of the present invention providing this feature, the access logic 150 monitors for and responds to a trigger to re-lock a part of a primary partition 122, 126 (i.e., to make it again be a secondary partition 124a-x, 128a-f, either generally be such or even to be the same specific one that it originally was).

Some examples of triggers for this are the passage of a period of time, an event internal to the electronic device 100, and/or an event external to the electronic device 100. The passage of a period of time can, of course, be regarded as an event internal to the electronic device 100, but it is listed separately and first here to emphasize how it particularly can be used in combination with other triggers. Most electronic devices 100 today have an internal clock (and many also are able to synchronize with an one). Accordingly, the passage of a period of time can easily be used as a Boolean trigger, that is, permitting something to happen or to not happen for a set period of time. For instance, a user of the electronic device 100 may simply purchase the right to enable all of the secondary partitions 124a-x, 128a-f for one year. These partitions are then unlocked, a clock is monitored, and after one-year the access logic 150 re-locks portions of the primary partitions 122, 126 to again create secondary partitions 124a-x, 128a-f. Alternately, a user of the electronic device 100 may subscribe to an online service wherein the secondary partitions 124a-x are unlocked for three months as a sign-up incentive and wherein they will remain unlocked as long as user maintains the subscription. Here the access logic 150 unlocks and sets a three month “do not turn off” trigger. Even if the user cancels their subscription the day after obtaining it and the access logic 150 detects that the subscription is no longer active, the access logic 150 here will with wait until at least the three month period has expired before re-locking the secondary partitions 124a-x. Still alternately, a manufacturer may not want their vendors steering potential purchasers to low-capacity enabled devices over high-capacity enabled ones. Here a six month “do not turn on” trigger can be set (perhaps one that further is initiated by initial user activation of the device), and the access logic 150 here will not enable anything (even with a proper key) until at least six months has passed.

And before wrapping up discussion of the electronic device 100 and the activation mechanisms 300 here, some additional remarks about the keys 310 is also appropriate. A very wide variety of types of keys may be used.

In simple embodiments of the present invention the keys 310 may be simple passwords. For example, although not shown in the figures, and not expected to be used frequently, a simple key, such as password, could be recited to or left as a voice mail message for an end user of an electronic device. The end used could then manually enter the key into the electronic device in response to a dialog provided by the access logic. Note, this or one where a key is e-mailed to a user and then cut and pasted into an access logic dialog may especially be useful in technical support scenarios.

In most embodiments, however, it is expected that the keys 310 will be more sophisticated. For instance they may be complex bit or character strings. They may be values generated with a formula, random values, hash values, symmetric encryption keys, asymmetric encryption keys, etc. They may or may not be unique. What is used as a key and how robust and secure the manner of its generation and use are matters of design choice, and the present invention is accordingly can be embodied to accommodate a very wide range of application scenarios.

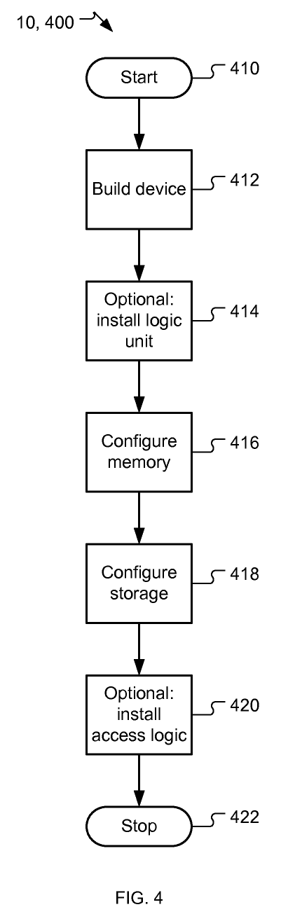

FIG. 4 is a flow chart of a manufacturing process 400 that may be used in the inventive system 10 for manufacturing the electronic device 100 in FIG. 1. For the sake of example the electronic device 100 here has both memory 112 and storage 114 and both are upgradable.

The manufacturing process 400 begins in step 410. Initialization and set-up typically occur here. For example, design of the electronic device 100 occurs here and components with specific capacities are chosen (e.g., components for the memory 112 and or the storage 114).

In a step 412 the electronic device 100 is built, generally. The components actually used here for the memory 112 and the storage 114 may be those chosen in design or they may be others with equal or greater capacities).

In an optional step 414 the logic unit 148 is included in the electronic device 100. This is optional because the logic unit 148 is provided and used in some embodiments of the electronic device 100 and not required or used in others.

In a step 416 the memory 112 in the electronic device 100 is configured with the capacity of the memory 112 that the electronic device 100 will initially be able to employ. A key point here, however, is that the memory 112 is configured to have a capacity less than what is actually installed in the electronic device 100.

In a step 418 the storage 114 in the electronic device 100 is configured with the capacity of the storage 114 that the electronic device 100 will initially be able to employ. A key point here (in this example where the memory 112 and storage 114 are both upgradable) is that the storage 114 is also configured to have a capacity less than what is actually installed in the electronic device 100.

In an optional step 420 a copy of the access logic 150 may be provided in the electronic device 100. This copy may be placed in the controller 110 or the logic unit 148, say, in read only memory (ROM) in one of these, or this copy may be stored in the storage 114. This step is optional because having a copy of the access logic 150 “built in” in this manner during manufacturing is not a requirement. A copy of the access logic 150 can alternately be obtained later, say, by an end user of the electronic device 100, for instance, via the media-based mechanism 300a, the wireless-based mechanism 300b, or the network-based mechanism 300c.

Finally, in a step 422 the manufacturing process 400 ends. The electronic device 100 is now complete and ready to be provided to a vendor or directly to an end user.

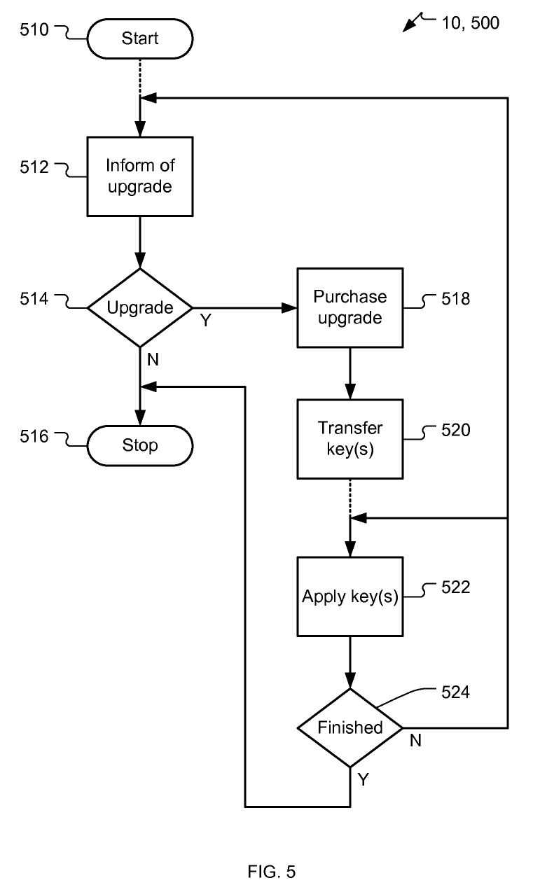

FIG. 5 is a flow chart of an upgrade process 500 that may be used in the inventive system 10 to enable access to additional memory and/or storage capacity in the electronic device 100 in FIG. 1 by using one of the activation mechanisms 300 in FIG. 2.

The upgrade process 500 begins in step 510. Initialization and set-up typically occur here. For instance, the electronic device 100 reaches an end user by some means, e.g., by their purchasing it themselves, receiving it as a gift, or being given it by their employer. Typically, the electronic device 100 is also activated here in some manner by or for the end user. This is optional, however, and can vary and be very device specific based on the nature of the electronic device 100. For example, activation of a MP3 player is typically not needed. In contrast, activation of a personal computer (PC) is typically performed by a new user upon first powering up the device. And in further contrast, activation of a cellular telephone for a new user is typically performed by a service provider.

In a step 512, at some later time (emphasized with a dashed line in FIG. 5), the user is informed that they may upgrade the memory 112, the storage 114, or both in the electronic device 100. Typically this is done by a running instance of the access logic 150 that uses the output interface 136 and the output device 134 of the electronic device 100 to deliver a message to the user. The access logic 150 can employ a variety of triggers for this, e.g., initial user activation, the passage of a set period of time, a set amount of usage, use of a substantial amount of the available capacity, etc. Alternately, the user may be aware about the option of upgrading and they themselves can trigger the access logic 150 to start an upgrade dialog.

In a step 514 the access logic 150 determines whether the user of the electronic device 100 has elected to upgrade the memory 112 and/or the storage 114. Typically this is done by a running instance of the access logic 150 monitoring the input interface 132 and the input device 130 for a user reply. Alternately, if the electronic device 100 detects that an instance of the media-based mechanism 300a has been loaded into the media reader 138, an instance of the access logic 150 present there may be run, e.g., with an autorun dialog as common in PCs.

If the user does not want to upgrade, in straightforward manner a step 516 follows where the upgrade process 500 ends. An optional part of step 516, however, can be a dialog informing the user that they can configure future occurrences of step 512. For instance, the user can be informed that they can set or change triggers for step 512, or even to turn off all triggers so that it will not automatically occur again.

Alternately, if the user does want to upgrade, a step 518 follows wherein the right to an upgrade is purchased. The term “purchase” apples very broadly here to mean that something of value is given in exchange for the right to an upgrade. For example, in many embodiments it is expected that the user or their employer can simply pay money for an upgrade, say, with a credit card. But users of some embodiments might instead “purchase” the right to an upgrade by registering for a service that provides a utility (e.g., telephone or Internet access), or a user may take an online survey or provide information about themselves such as an e-mail address.

After successful completion of step 518, a step 520 follows wherein one or more of the keys 310 are transferred to the electronic device 100. Optionally, a copy of the access logic 150 can also be transferred here. If the electronic device 100 does already not have a copy, one will be need before the keys 310 can be used and this is a good time to procure it. Alternately, if the electronic device 100 has an older version of the access logic 150, this may be a suitable time to provide a newer version.

In a step 522, at some later time (emphasized with a dashed line in FIG. 5), one or more or all of the keys that were received in step 520 are applied by the access logic 150. Typically the received keys are applied as soon as they are received by the electronic device 100, but this is not a requirement. Also typical, all of the received keys are usually applied together, but this also is not a requirement. The access logic 150 now enables the portions of the secondary blocks 124, 128 that are associated with the received keys 310 that are being applied.

In a step 524 a decision is made whether to stop the upgrade process 500. This decision can be made by the access logic 150 or by the user. If all of the available capacities have now been enabled, the access logic can detect this and have step 516 automatically follow so the upgrade process 500 ends. Alternately, the user can be asked here if they want to stop (proceed to step 516) or return to step 512. For instance, the user may feel that this upgrade was so inexpensive and went so smoothly that they want to go ahead and upgrade further. Or the user may have procured more keys 310 than were applied in step 522, and here they can continue to apply some or all of those as well.

With reference again briefly to FIG. 3, the stylized depiction of the electronic device 100 there includes a few representative examples. Without limitation to the specific examples shown, which are merely those that conveniently fit in the available space in FIG. 3, these represent the variety of consumer electronic devices wherein the inventive system 10 may provide immediate substantial benefit. While various embodiments of the electronic device 100, the activation mechanisms 300, manufacturing process 400, and upgrade process 500 have all been described above with the inventive system 10, it should be understood that they have been presented by way of example only, and that the breadth and scope of the invention should not be limited by any of the above described exemplary embodiments, but should instead be defined only in accordance with the following claims and their equivalents.

What is claimed is:

1. An electronic device, comprising:
a controller having a processor that works with a memory and a storage;
said memory having a primary memory partition that is accessible by said processor and further having a secondary memory partition that is prevented from being accessed by said processor until enabled when an access logic is run in the electronic device with a key associated with said secondary memory partition; and
said storage having a primary storage partition that is accessible by said processor and further having a secondary storage partition that is prevented from being accessed by said processor until enabled when said access logic is run in the electronic device with a said key associated with said secondary storage partition.

2. An electronic device, comprising:
a controller having a processor that works with a memory; and
said memory having a partition that is prevented from being accessed by said processor until enabled when an access logic is run in the electronic device with a key associated with said partition.

3. An electronic device, comprising:
a controller having a processor that works with a storage; and
said storage having a partition that is prevented from being accessed by said processor until enabled when an access logic is run in the electronic device with a key associated with said partition.

4. The electronic device of any of claims 1-3, wherein said access logic is run in said processor.

5. The electronic device of any of claims 1-3, wherein the electronic device further comprises a logic unit, and wherein:
said processor in said controller is a first processor;
said logic unit includes a second processor; and
said access logic is run in said second processor.

6. The electronic device of any of claims 1-3, further comprising an input system for the electronic device to receive a said key from a source external to the electronic device.

7. The electronic device of claim 6, wherein said input system includes a media reader to read a said key from a computer readable storage medium.

8. The electronic device of claim 6, wherein said input system includes an interface to receive a said key from said source external to the electronic device via a communications network.

9. A method for manufacturing an electronic device having additional memory and storage capacities, comprising:
building the electronic device to include a controller having a processor that works with a memory and a storage;
configuring said memory to have a primary memory partition that is accessible by said processor and further to have at least one secondary memory partition that is prevented from being accessed by said processor until enabled by an access logic running in the electronic device with a key associated with said secondary memory partition; and
configuring said storage to have a primary storage partition that is accessible by said processor and further to have at least one secondary storage partition that is prevented from being accessed by said processor until enabled by said access logic running in the electronic device with a key associated with said secondary storage partition.

10. A method for manufacturing an electronic device having additional memory capacity, comprising:
building the electronic device to include a controller having a processor that works with a memory; and
configuring said memory to have a partition that is prevented from being accessed by said processor until enabled by an access logic running in the electronic device with a key associated with said partition.

11. A method for manufacturing an electronic device having additional storage capacity, comprising:
building the electronic device to include a controller having a processor that works with a storage; and
configuring said storage to have a partition that is prevented from being accessed by said processor until enabled by an access logic running in the electronic device with a key associated with said partition.

12. The method of any of claims 9-11, wherein said building further includes providing said access logic stored in said controller such that said access logic is run in said processor.

13. The method of any of claims 9-11, wherein said building further includes providing a logic unit, distinct from said controller, wherein said access logic is stored in said logic unit such that said access logic is run in said logic unit.

14. The method of any of claims 9-11, wherein said building further includes providing an input system for the electronic device to receive said key from a source external to the electronic device.

15. The method of claim 14, wherein said input system includes a media reader to read said key from a computer readable storage medium.

16. The method of claim 14, wherein said input system includes an interface to receive said key from a said source external to the electronic device via a communications network.

17. A method for a user of an electronic device to upgrade access to an additional memory capacity and to an additional storage capacity when the electronic device includes a processor, a memory, and a storage wherein the memory has a memory partition that is prevented from being accessed by the processor until enabled by an access logic being run in the electronic device with a key associated with the memory partition, and wherein the storage has a storage partition that is prevented from being accessed by the processor until enabled by said access logic being run in the electronic device with a key associated with the storage partition, the method comprising:
running the access logic in the electronic device;
informing the user that an upgrade permitting access to the additional memory capacity and the additional storage capacity is available;
determining if the user wishes said upgrade and, if so:
permitting the user to purchase said upgrade;
transferring the key associated with the memory partition to the electronic device from a source external to the electronic device;
transferring the key associated with the storage partition to the electronic device from said source external to the electronic device;
applying the key associated with the memory partition with the access logic to enable the memory partition; and
applying the key associated with the storage partition with the access logic to enable the storage partition.

18. A method for a user of an electronic device to upgrade access to an additional memory capacity when the electronic device includes a processor and a memory having a partition that is prevented from being accessed by the processor until enabled by an access logic being run in the electronic device with a key, the method comprising:
running the access logic in the electronic device;
informing the user that an upgrade permitting access to the additional memory capacity is available;
determining if the user wishes said upgrade and, if so:
permitting the user to purchase said upgrade;
transferring the key to the electronic device from a source external to the electronic device;
applying the key with the access logic to enable the partition.

19. A method for a user of an electronic device to upgrade access to an additional storage capacity when the electronic device includes a processor and a storage having a partition that is prevented from being accessed by the processor until enabled by an access logic being run in the electronic device with a key, the method comprising:
running the access logic in the electronic device;
informing the user that an upgrade permitting access to the additional storage capacity is available;
determining if the user wishes said upgrade and, if so:
permitting the user to purchase said upgrade;
transferring the key to the electronic device from a source external to the electronic device;
applying the key with the access logic to enable the partition.

20. The method of any of claims 17-19, prior to said running, the method further comprising loading the access logic from a location external to the electronic device.

21. The method of any of claims 17-19, wherein the electronic device has an input system that includes a media reader, and wherein said source external to the electronic device is in a computer readable storage media placed in the media reader.

22. The method of any of claims 17-19, wherein the electronic device has an input system that includes an interface, and wherein said source external to the electronic device is on a communications network accessed with said interface.

23. The method of any of claims 17-19, wherein said running includes monitoring for a trigger and performing said informing only if said trigger specifically has or specifically has not occurred.

24. The method of any of claims 17-19, subsequent to said applying, the method further comprising monitoring for a trigger, and if said trigger specifically has or specifically has not occurred disabling the partition that was enabled in said applying.

25. The method of any of claims 23-24, wherein said trigger is the passage of a period of time.
